(19) United States
(12) Patent Application Publication
(10) Pub. No.: US 2010/0057558 A1
(43) Pub. Date: Mar. 4, 2010

(54) WEB ADVERTISING EFFECTIVENESS MEASURING APPARATUS, WEB ADVERTISING EFFECTIVENESS MEASURING METHOD, AND, COMPUTER PROGRAM PRODUCT FOR THE SAME

(76) Inventor: Hironori YANO, Ashigarakami-gun (JP)

Correspondence Address: BIRCH STEWART KOLASCH & BIRCH, PO BOX 747, FALLS CHURCH, VA, 22040-0747, US

(21) Appl. No.: 12/540,404

(22) Filed: Aug. 13, 2009

(30) Foreign Application Priority Data
Sep. 1, 2008 (JP) 2008-223667

(51) Int. Cl. G06Q 30/00; G06K 9/00; G06F 3/048

(52) U.S. Cl. 705/14.45; 382/103; 715/786

(57) ABSTRACT

A web advertising effectiveness measuring apparatus measures a viewing time period of an advertisement on a web page displayed on a display device of a user terminal, the apparatus includes: a device for acquiring window information including a location and a size of a window in which the web page is displayed; an device for acquiring advertisement information including a location and a size of the advertisement; a device for acquiring a display area of the advertisement; a device for taking images of a user; an device for detecting an eye direction of the user based on the images; a device for making a determination whether the advertisement is on a visual line of the user; a device for measuring the viewing time period based on the determination; and a device for linking and storing the viewing time period and the advertisement information.

### BACKGROUND OF THE INVENTION

1. Field of the Invention

The present invention relates to a web advertising effectiveness measuring apparatus, a web advertising effectiveness measuring method, and a computer program product for the same, and particularly, to a web advertising effectiveness measuring apparatus, a web advertising effectiveness measuring method, and a computer program product for the same capable of measuring an actual advertisement viewing time period.

2. Description of the Related Art

A field called web advertising has established a certain status along with the development of the Internet technology of recent years. Web advertising is a mechanism of inserting images, links, and descriptions of products and companies advertised on websites and presenting information to visitors of the websites.

Important elements in web advertising include page views of a website on which the advertisement is posted, the website stay time, and the number of link clicks. Japanese Patent Application Laid-Open No. 2006-323629 discloses an invention in which an advertiser of a web advertisement collects above mentioned information and measures a degree of an advertising effectiveness.

Meanwhile, Japanese Patent Application Laid-Open Nos. 11-034772 and 2007-293544 disclose inventions of methods for measuring the advertising effectiveness when the advertisement is posted on a bulletin board at a street corner or on a window of a building. In the methods, a camera is mounted on the bulletin board on which the advertisement is posted, and a face recognition technique and a visual line detection technique as described in Japanese Patent Application Laid-Open No. 2008-102902 are used to detect which advertisement on the bulletin board is viewed. The inventions described in Japanese Patent Application Laid-Open Nos. 11-034772 and 2007-293544 are used for the measurement of the advertising effectiveness and for marketing.

### SUMMARY OF THE INVENTION

However, it is difficult to determine whether the web advertisement is actually read or to measure an accurate advertisement viewing time period based on the page views and the site stay time as in the invention described in Japanese Patent Application Laid-Open No. 2006-323629.

For example, considering a case in which a web page is opened and another operation is performed for a long time while the page is not viewed, the web page is not actually viewed although the stay time of the web page is long. Thus, there is a deviation between the stay time and the actual viewing time period of the web page, and the stay time of the web page cannot be assumed as the actual viewing time period.

The inventions described in Japanese Patent Application Laid-Open Nos. 11-034772 and 2007-293544 are techniques that can be implemented only if there is an advertisement on the visual line and the advertisement content can be recognized. Therefore, the inventions described in Japanese Patent Application Laid-Open Nos. 11-034772 and 2007-293544 cannot be applied to the web advertising with a possibility that the advertisement does not exist on the visual line, because a user can arbitrarily change a display area of the advertisement.

The present invention has been made in view of the foregoing circumstances, and an object of the present invention is to provide a web advertising effectiveness measuring apparatus, a web advertising effectiveness measuring method, and a computer program product for the same capable of determining whether a web advertisement is actually viewed and measuring an actual viewing time period of the web advertisement if the web advertisement is viewed.

A first aspect of the present invention provides a web advertising effectiveness measuring apparatus for measuring a viewing time period of an advertisement on a web page displayed on a display device of a user terminal, the web advertising effectiveness measuring apparatus including: a window information acquisition device for acquiring window information including a location of a window in which the web page is displayed in a screen of the display device and a size of the window; an advertisement information acquisition device for acquiring advertisement information including a location of the advertisement in the web page and a size of the advertisement; a display area acquisition device for acquiring a display area of the advertisement on the display device based on the acquired window information and the acquired advertisement information; an imaging device for taking images of a user, the imaging device being arranged on a predetermined location on the display device; an eye direction detection device for detecting an eye direction of the user based on the images taken by the imaging device; a determination device for making a determination whether the advertisement is on a visual line of the user based on the eye direction of the user detected by the eye direction detection device and the display area of the advertisement on the display device acquired by the display area acquisition device; a viewing time period measuring device for measuring the viewing time period based on a result of the determination by the determination device, the viewing time period being a time period during which the advertisement is determined to be on the visual line of the user; and a viewing information storage device for linking the viewing time period measured by the viewing time period measuring device and the advertisement information, and storing the viewing time period and the advertisement information.

According to the web advertising effectiveness measuring apparatus of the first aspect, the advertisement on the web page is displayed on the window, and the window information including the location of the window and the size of the window, and the advertisement information including the location of the advertisement and the size of the advertisement in the web page are acquired. A display area on the display device of the advertisement is acquired based on the acquired window information and the acquired advertisement information. Images of the user are taken, and the eye direction of the user is detected based on the images taken. Whether the advertisement is on the visual line of the user is determined based on the acquired display area on the display device of the advertisement and the eye direction of the user. A viewing time period, which is a time period during which the advertisement is determined to be on the visual line of the user, is measured based on the result of the determination, and the measured viewing time period and the advertisement information are linked and stored. As a result, whether the advertisement posted on the web page displayed on an arbitrary location on the monitor is viewed by the user and the viewing time period of the advertisement if the advertisement is viewed can be accurately recognized.

A second aspect of the present invention provides the web advertising effectiveness measuring apparatus according to the first aspect, wherein the window information acquisition device acquires the window information including a location of a scroll bar of the window.

According to the web advertising effectiveness measuring apparatus of the second aspect, the window information including the location of the window and the size of the window and the location of the scroll bar of the window is acquired. As a result, the display area of the advertisement posted on the web page can be acquired even if the window is small.

A third aspect of the present invention provides the web advertising effectiveness measuring apparatus according to the first or the second aspect, further comprising a device for determining whether the advertisement is viewable by the user when a plurality of windows including the window in which the web page is displayed are overlapped on the display device, wherein the viewing time period measuring device measures the viewing time period only when the device determines that the advertisement is viewable by the user.

According to the web advertising effectiveness measuring apparatus of the third aspect, the device is included that determines whether the advertisement is viewable by the user when a plurality of windows including the window in which the web page is displayed are overlapped on the display device. The viewing time period of the advertisement is measured only when the device determines that the advertisement is viewable by the user. As a result, more accurate advertisement viewing information can be acquired.

A fourth aspect of the present invention provides the web advertising effectiveness measuring apparatus according to any one of the first to the third aspects, wherein the advertisement information acquisition device acquires information indicating whether the advertisement includes a text, the eye direction detection device detects a moving direction of the eye direction of the user, the web advertising effectiveness measuring apparatus further comprising a device for determining that the user is reading the text if the advertisement information acquisition device acquires the information indicating the advertisement includes the text, the eye direction detection device detects that the eye direction of the user moves horizontally, and the determination device determines that the advertisement is on the visual line of the user.

According to the web advertising effectiveness measuring apparatus of the fourth aspect, if it is detected that the advertisement includes a text is acquired, and that the visual line of the user moves horizontally, and the advertisement is determined to be on the visual line of the user, then the user is determined to be reading the text. As a result, more detailed advertisement viewing information can be acquired.

A fifth aspect of the present invention provides the web advertising effectiveness measuring apparatus according to any one of the first to the fourth aspects, further comprising a device for revising information including at least one of the location of the window displayed on the display device and the size of the window, wherein the display area acquisition device acquires the display area of the advertisement on the display device according to the updated information.

According to the web advertising effectiveness measuring apparatus of the fifth aspect, when a change in at least one of the location and the size of the window is inputted, the changed display area of advertisement is acquired. As a result, the advertisement viewing information can be surely recognized even if the user changes the display area of the advertisement.

A sixth aspect of the present invention provides the web advertising effectiveness measuring apparatus according to any one of the first to the fifth aspects, wherein the advertisement information acquisition device acquires a contact information of an advertiser of the advertisement, the web advertising effectiveness measuring apparatus further comprising a device for transmitting the viewing time period of the advertisement of the advertiser measured by the viewing time period measuring device to the advertiser by using the contact information of the advertiser acquired by the advertisement information acquisition device.

According to the web advertising effectiveness measuring apparatus of the sixth aspect, the contact information of the advertiser of the advertisement is acquired, and the measured viewing time period is transmitted to the acquired contact information. As a result, the user can use the viewing time period in the measurement of the advertising effectiveness or in the marketing.

A seventh aspect of the present invention provides a web advertising effectiveness measuring method for measuring a viewing time period of an advertisement on a web page displayed on a display device of a user terminal, the web advertising effectiveness measuring method comprising: a step of acquiring window information including a location of a window in which the web page is displayed in a screen of the display device and a size of the window; a step of acquiring advertisement information including a location of the advertisement in the web page and a size of the advertisement; a step of acquiring a display area of the advertisement on the display device based on the acquired window information and the acquired advertisement information; a step of acquiring images of a user photographed by an imaging device for taking images of the user, the imaging device being arranged on a predetermined location on the display device; a step of detecting an eye direction of the user based on the acquired images; a step of making a determination whether the advertisement is on the visual line of the user based on the detected eye direction of the user and the acquired display area of the advertisement on the display device; a step of measuring a viewing time period based on a result of the determination in the step of making the determination whether the advertisement is on the visual line of the user, the viewing time period is a time that the advertisement is determined to be on the visual line of the user; and a step of linking the measured viewing time period and the advertisement information, and storing the measured viewing time period and the advertisement information.

An eighth aspect of the present invention provides a computer program product for measuring a viewing time period of an advertisement on a web page displayed on a display device of a user terminal, the computer program product comprising: computer-readable program code for causing a computer to acquire window information including a location of a window in which the web page is displayed in a screen of the display device and a size of the window; computer-readable program code for causing the computer to acquire advertisement information including a location of the advertisement in the web page and a size of the advertisement; computer-readable program code for causing the computer to acquire a display area of the advertisement on the display device based on the acquired window information and the acquired advertisement information; computer-readable program code for causing the computer to acquire images of a user photographed by an imaging device for taking images of the user, the imaging device being arranged on a predetermined location on the display device; computer-readable program code for causing the computer to detect an eye direction of the user based on the acquired images; computer-readable program code for causing the computer to make a determination whether the advertisement is on the visual line of the user based on the detected eye direction of the user and the acquired display area of the advertisement on the display device; computer-readable program code for causing the computer to measure a viewing time period based on a result of the determination in the step of determining whether the advertisement is on the visual line of the user, the viewing time period is a time that the advertisement is determined to be on the visual line of the user; and computer-readable program code for causing the computer to link the measured viewing time period and the advertisement information, and to store the measured viewing time period and the advertisement information.

According to the present invention, whether the web advertisement is actually viewed can be determined, and the actual viewing time period of the web advertisement can be measured if the web advertisement is viewed.

### BRIEF DESCRIPTION OF THE DRAWINGS

FIG. 1 is a block diagram of a web advertising effectiveness measuring apparatus 1 applied with the present invention;

FIG. 2 is a diagram of a relationship between a monitor 11 and a display location of a window;

FIG. 3 is a diagram of a relationship between a window and a display area of advertisement;

FIG. 4 is an example of a window information table;

FIG. 5 is an example of an advertising site information table;

FIG. 6 is an example of an advertisement viewing information table;

FIG. 7 is a flow chart of a flow of a creation process of the advertisement viewing information table of the web advertising effectiveness measuring apparatus 1; and

FIG. 8 is a flow chart of a flow of a creation process of the advertisement viewing information table of a web advertising effectiveness measuring apparatus 2.

### DETAILED DESCRIPTION OF THE PREFERRED EMBODIMENTS

### First Embodiment

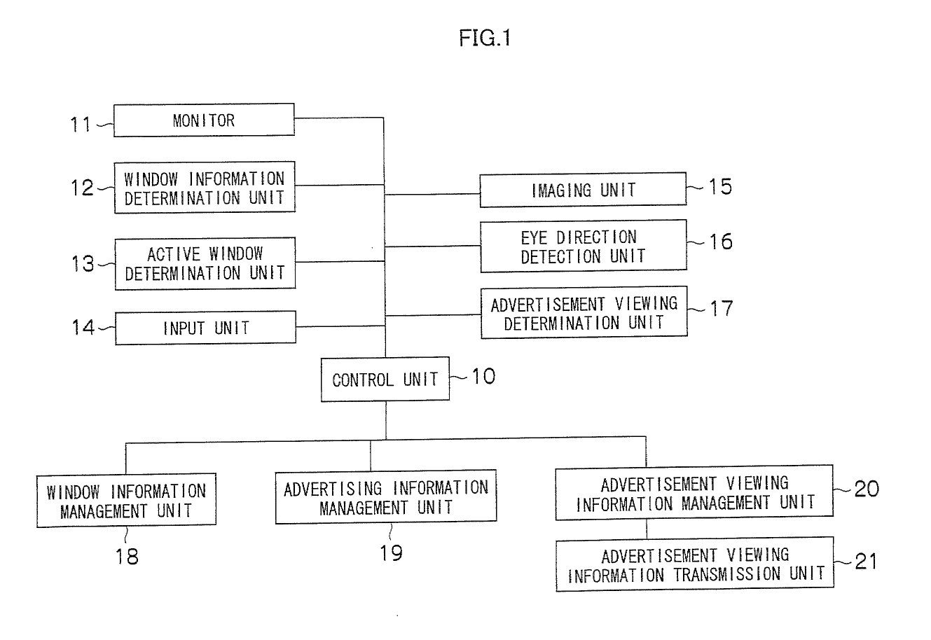

FIG. 1 is a block diagram of the entire configuration of a web advertising effectiveness measuring apparatus 1 of the present embodiment. The web advertising effectiveness measuring apparatus 1 includes a control unit 10, a monitor 11, a window information determination unit 12, an active window determination unit 13, an input unit 14, an imaging unit 15, an eye direction detection unit 16, an advertisement viewing determination unit 17, a window information management unit 18, an advertisement viewing information management unit 20, an advertisement information management unit 19, and an advertisement viewing information transmission unit 21.

The control unit 10 functions as a control device which comprehensively controls the entire operation of the web advertising effectiveness measuring apparatus 1 and functions as a calculation device which performs various calculation processes. The control unit 10 includes a memory area storing a firmware as a control program, a browser as a program for displaying a web page, and various data necessary for the control. The control unit 10 also includes a memory area used as a working area of the control unit 10 and as a temporary storage area of image data for display.

The control unit 10 is connected to the Internet (not illustrated) and acquires various data such as a URL and an Html file of the web page through the Internet. The control unit 10 activates the browser and analyzes the acquired Html file to display a window on which the web page is displayed at a predetermined location of the monitor 11. When the input unit 14 performs an input, the control unit 10 changes the display location of the window to the location of the input.

The control unit 10 analyzes the acquired Html data to determine whether an advertisement is posted on the web page, and if the advertisement is posted, acquires advertisement information such as the URL of the advertising site, a content of the advertisement (attribute such as image data, text data, or both image data and text data), and the location of the advertisement and the size of the advertisement on the web page. Information described in meta tags can be used as the advertisement information. The control unit 10 periodically accesses the advertising site on which the advertisement is posted, and acquires the Html data to acquire the advertisement information. The control unit 10 outputs the acquired advertisement information to the advertisement information management unit 19.

The monitor 11 is a liquid crystal display capable of color display and is used as a user interface display panel in various setting operations.

Based on the result of the analysis of the control unit 10, the window information determination unit 12 determines whether the web page displayed in the window includes the advertisement. The window information determination unit 12 determines the location of the window and the size of the window displayed on the monitor 11 and calculates an area (hereinafter, “display area of advertisement”) on the monitor 11 displaying the advertisement if the web page displayed in the window includes the advertisement.

A calculation method of the display area of advertisement will be described. First, the window information determination unit 12 determines the location of the window and the size of the window displayed on the monitor 11. This process is executed every time the browser displays the window and every time the display location of the window is changed by the input unit 14.

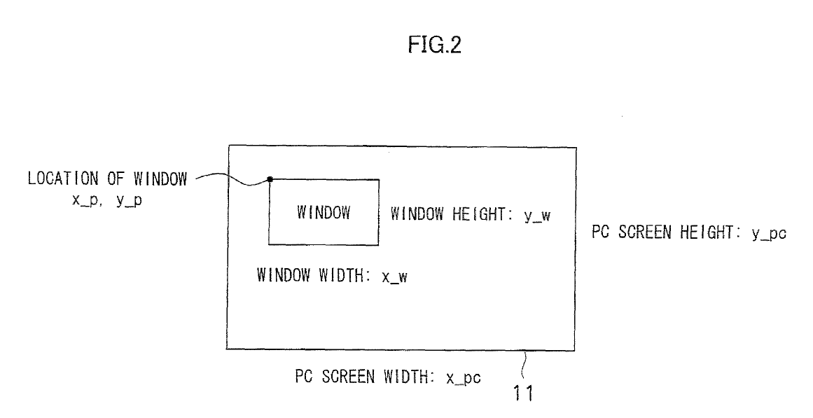

FIG. 2 shows a relationship between the monitor 11 and the display location of the window. As shown in Table 1, the window information determination unit 12 uses coordinates (hereinafter, “the location of the window”) of a point on the upper left of the window and the size of the window to acquire the display location of the window on the monitor 11. Above mentioned values are outputted to the window information management unit 18 and stored in a window information table (described in detail below).

TABLE 1

| | | |
|---|---|---|
| Location of Window | x coordinate | x_p |
| | y coordinate | y_p |
| Size of Window | Width | x_w |
| | Height | y_w |

The window information determination unit 12 acquires the location of the window and the size of the window from the window information table stored in the window information management unit 18 and calculates the area on the monitor 11 displaying the window (See Expression 1).

x coordinate of display location of window x_{—}p≦x≦x_{—}p+x_{—}w [Expression 1]

y coordinate of display location of window y_{—}p≦y≦y_{—}p+y_{—}w

Then, the window information determination unit 12 calculates the area in which the advertisement is displayed in the window to display the advertisement. This process is executed every time the browser displays the window and the web page displayed in the window is determined to include the advertisement and every time the display location of the window to display the web page including the advertisement is changed by the input unit 14.

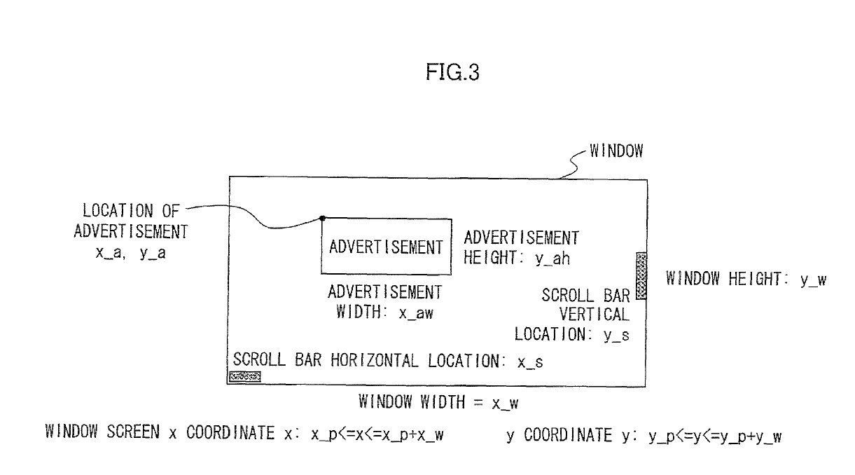

FIG. 3 shows a relationship between the window and the display area of the advertisement. As shown in Table 2, the window information determination unit 12 uses coordinates (hereinafter, “the location of the advertisement”) of a point on the upper left of the advertisement, the size of the advertisement, and a location of a scroll bar to acquire the display location of the advertisement of the window. Above mentioned values are outputted to the advertisement information management unit 19 and stored in the advertising site information table (described in detail later).

TABLE 2

| | | |
|---|---|---|
| Location of Advertisement | x coordinate | x_a |
| | y coordinate | y_a |
| Size of Advertisement | Width | x_aw |
| | Height | y_ah |
| Location of Scroll Bar | Horizontal | x_s |
| | Vertical | y_s |

The window information determination unit 12 acquires the location of the advertisement, the size of the advertisement, and the location of the scroll bar from the advertising site information table stored in the advertisement information management unit 19 and calculates the location of the advertisement on the monitor 11 (See Expression 2).

x coordinate of display area of advertisement

x_{—}p+x_{—}a−x_{—}s≦x≦x_{—}p+x_{—}a+x_{—}aw−x_{—}s [Expression 2]

Y coordinate of display area of advertisement

y_{—}p+y_{—}a−y_{—}s≦y≦y_{—}p+y_{—}a+y_{—}ah−y_{—}s

The active window determination unit 13 makes a determination whether the window is an active window (window displayed at the front of the monitor 11). The result of the determination is outputted to the advertisement viewing information management unit 20.

The input unit 14 includes a keyboard, a mouse, etc. The input unit 14 inputs a change in active or inactive of the window displayed on the monitor 11 and a change in the location of the window or the size of the window.

The imaging unit 15 is arranged near (above, for example) the monitor 11 and continuously takes images of the user's face in front of the monitor 11 based on an instruction from the control unit 10. The photographed images are outputted to the eye direction detection unit 16.

The eye direction detection unit 16 detects the user's eye direction from the images of the user's face photographed by the imaging unit 15. Various known methods, such as the method disclosed in Japanese Patent Application Laid-Open No. 2008-102902, can be used to detect the eye direction.

The advertisement viewing determination unit 17 determines whether there is the advertisement on the visual line of the user based on the eye direction detected by the eye direction detection unit 16 and the information described in the window information table and the advertising site information table (described in detail below).

The advertisement viewing determination unit 17 determines that the advertisement is not displayed on the monitor 11 if x and y calculated by Expression 2 are not within the range of x and y calculated by Expression 1, and determines that the advertisement is displayed on the monitor 11 if x and y calculated by Expression 2 is within the range of x and y calculated by Expression 1.

If the advertisement is determined to be displayed on the monitor 11, the advertisement viewing determination unit 17 (described in detail below) calculates the area of x and y satisfying Expression 2 as the display area of the advertisement.

Then, the advertisement viewing determination unit 17 calculates the coordinates on the monitor 11 where the eye direction detected by the eye direction detection unit 16 intersects with the monitor 11 and determines that the advertisement is on the visual line of the user if the calculated coordinates are included in the display area of the advertisement calculated by Expression 2.

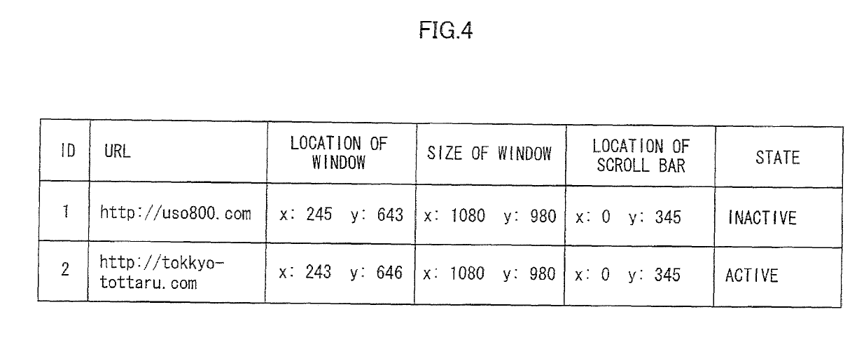

The window information management unit 18 stores and manages the window information table as a table displaying window information related to the window on the monitor 11. As shown in FIG. 4, the URL of the advertising site acquired by the control unit 10, the location of the window inputted from the window information determination unit 12, the size of the window, the location of the scroll bar, and the determination result (hereinafter, “state of window”) of active or inactive determined by the active window determination unit 13 are linked and stored in the window information table.

The IDs of the window information table denote values or characters uniquely allocated to each window, and the field of ID of FIG. 4 indicates the window IDs. The field of URL indicates the URLs of the advertising sites included in the web pages displayed in the windows. The location of the window indicates the locations of the windows on the monitor 11. The size of the window indicates the sizes of the windows on the monitor 11. The location of the scroll bar indicates the locations of the scroll bars in the windows. The field of state indicates whether the windows are active or inactive. Although the location of the window, the size of the window, and the location of the scroll bar are shown in pixels in FIG. 4, the location of the window, the size of the window, and the location of the scroll bar may be displayed in other ways.

When a new window opens, the window information management unit 18 adds data of the newly opened window inputted from the window information determination unit 12 or the active window determination unit 13 to the window information table. When the location of the window, the size of the window, the location of the scroll bar, or the state of the window of the opened window is changed, the window information management unit 18 revises the data of the window information table with the changed data inputted from the window information determination unit 12 or the active window determination unit 13.

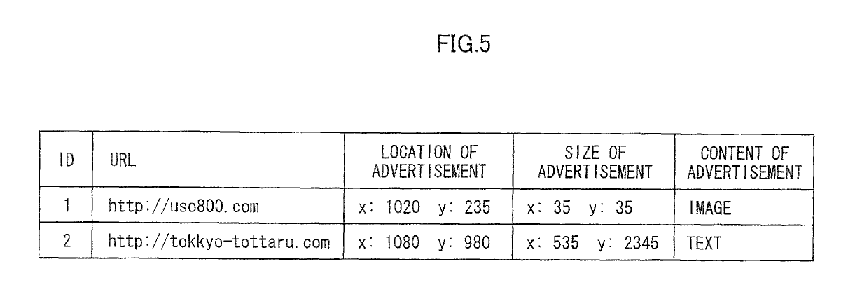

The advertisement viewing information management unit 20 stores and manages the advertising site information table that is a table of information of the advertising site in which the advertising effectiveness will be measured. As shown in FIG. 5, the URL of the web page acquired by the control unit 10, the location of the advertisement inputted from the window information determination unit 12, the size of the advertisement, and the content of the advertisement acquired by the control unit 10 are linked and stored in the advertising site information table.

The IDs of the advertising site information table are values or characters uniquely allocated to the advertisements, and the field of ID of FIG. 5 indicates the advertisement IDs. As in FIG. 4, the field of URL indicates the URLs of the advertising sites. The field of location of advertisement indicates the locations on the advertising windows. The field of size of advertisement indicates the sizes on the advertising windows. The field of content of advertisement indicates the attributes (text or image) of the advertisements. In FIG. 5, although the location of the advertisement and the size of the advertisement are shown in pixels, the location of the advertisement and the size of the advertisement may be displayed in other ways.

When a new window including an advertisement opens, the advertisement viewing information management unit 20 adds the data of the newly opened advertisement inputted from the window information determination unit 12 or the control unit 10 to the advertising site information table. When the location of the window, the size of the window, the location of the scroll bar, or the state of the window of the opened window is changed, the advertisement viewing information management unit 20 revises the location of the advertisement and the size of the advertisement of the advertising site information table with the changed location of the advertisement and the size of the advertisement inputted from the window information determination unit 12 or the active window determination unit 13.

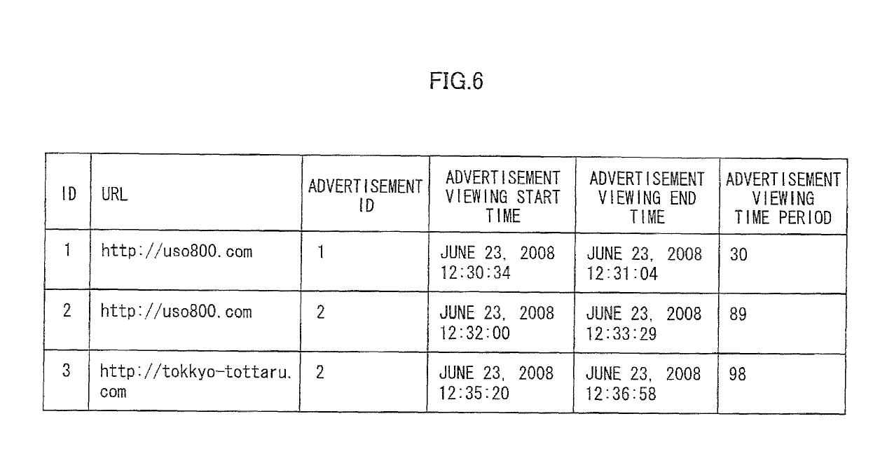

The advertisement information management unit 19 stores and manages advertisement viewing information table that is a table displaying advertisement viewing information. As shown in FIG. 6, the URLs of the web pages acquired by the control unit 10, IDs of the advertising site information table (hereinafter, “advertisement IDs”), advertisement viewing start time, advertisement viewing end time, and advertisement viewing time period are linked and stored in the advertisement viewing information table.

The IDs of the advertisement viewing information table are values or characters uniquely allocated to the viewing information of advertisement, and the field of ID of FIG. 6 indicates the advertisement IDs. As in FIG. 4, the field of advertisement ID indicates advertisement IDs. If the same advertisement is viewed for a plurality of times, a plurality of data with the same advertisement ID and different advertisement viewing information table IDs is stored in the advertisement viewing information table.

The advertisement viewing start time is time information of the moment when the advertisement viewing determination unit 17 determines that the advertisement is on the visual line of the user, and the field of advertisement viewing start time displays the date and time of the moment. The advertisement viewing end time is time information of the moment when the advertisement viewing determination unit 17 determines that the visual line of the user is out of the advertisement, and the field of advertisement viewing end time displays the date and time of the moment. The advertisement viewing time period is calculated by subtracting the advertisement viewing start time from the advertisement viewing end time and is indicated in seconds. The advertisement viewing time period may be shown not only in seconds, but also in minutes or hours.

The advertisement information management unit 19 creates the advertisement viewing information table when the browser is launched, makes an update every time the advertisement viewing determination unit 17 determines the advertisement viewing by the user, and closes the advertisement viewing information table when the browser is closed (update is not made afterwards). If the browser is launched again, the advertisement information management unit 19 creates a different advertisement viewing information table.

The advertisement viewing information transmission unit 21 is implemented by a generally used TCP/IP protocol, etc., and transmits the information stored in the advertising site information table of the advertisement viewing information management unit 20 to the advertiser in an arbitrary form. The advertisement viewing information transmission unit 21 transmits the entire data of the advertisement viewing information table when the advertisement information management unit 19 closes the advertisement viewing information table. The method of transmitting the information to the advertiser is not limited to this, and email may also be used. The email address can be acquired by the analysis of the Html data acquired by the control unit 10.

In the present embodiment, the advertisement viewing information management unit 20, the advertisement information management unit 19, and the advertisement viewing information transmission unit 21 are arranged in the web advertising effectiveness measuring apparatus 1. However, the advertisement viewing information management unit 18, the advertisement information management unit 19, and the advertisement viewing information transmission unit 21 may be arranged on a server apparatus separate from the web advertising effectiveness measuring apparatus 1. The server apparatus and the web advertising effectiveness measuring apparatus 1 may be connected through a network.

An operation of the web advertising effectiveness measuring apparatus 1 configured this way will be described.

As the control unit 10 activates the web browser, the window information determination unit 12 acquires and outputs the location of the advertisement of the window displayed on the monitor 11, the size of the advertisement, and the location of the scroll bar to the advertisement information management unit 19. The active window determination unit 13 makes a determination whether the window displayed on the monitor 11 is active and outputs a result of the determination to the advertisement information management unit 19. The window information management unit 18 stores the inputted information in the window information table.

The window information determination unit 12 acquires information, such as the URL of the advertising site currently displayed on the monitor 11, the location of the window, and the size of the window, and outputs the information to the window information management unit 18. The advertisement information management unit 19 stores the inputted information to the advertising site information table.

The process is executed every time the window configuration displayed on the monitor 11 is changed, and the window information table and the advertising site information table are updated. The advertising site information table is further updated every time the control unit 10 periodically acquires the Html data and outputs the advertisement information to the advertisement information management unit 19.

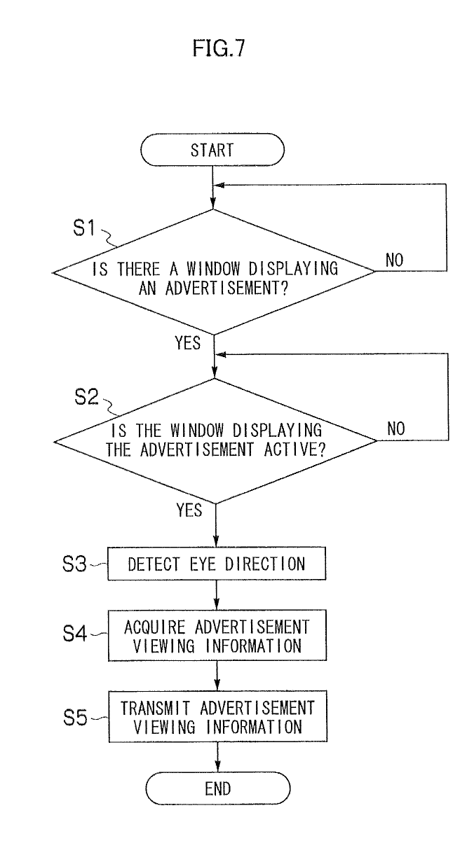

Then, the control unit 10 starts creating the advertisement viewing information table. FIG. 7 is a flow chart of a flow of a process for creating the advertisement viewing information table of the first embodiment.

The control unit 10 acquires the window information table and the advertising site information table and determines whether the window of the web page including an advertisement is displayed on the monitor 11 (step S1).

If the window of the web page including the advertisement is not displayed on the monitor 11 (NO in step S1), step S1 is executed again.

If the window of the web page including the advertisement is displayed on the monitor 11 (YES in step S1), the control unit 10 issues an instruction to the active window determination unit 13, and the active window determination unit 13 determines whether the window determined to include the advertisement in step S1 is an active window (step S2). The determination result is inputted to the control unit 10.

If the window determined to include the advertisement in step S1 is not an active window (NO in step S2), step S2 is executed again.

If the window determined to include the advertisement in step S1 is an active window (YES in step S2), the control unit 10 issues an instruction to the imaging unit 15. The imaging unit 15 continuously takes images of the face of the user in front of the monitor 11, and the eye direction detection unit 16 detects the eye direction of the user from the images of the face of the user taken by the imaging unit 15 (step S3). The detected eye direction of the user is inputted to the advertisement viewing determination unit 17.

The advertisement viewing determination unit 17 measures the location on the screen on the visual line of the user based on the eye direction detected by the eye direction detection unit 16 in step S3. The advertisement viewing determination unit 17 acquires the window information table and the advertising site information table and acquires the display area of the advertisement displayed on the active window based on the data stored in the tables. Based on the above mentioned information, the advertisement viewing determination unit 17 determines whether the location on the screen on the visual line is in the display area of advertisement.

The advertisement viewing determination unit 17 acquires the latest tables every time the window information table and the advertising site information table are updated. In this way, the user can recognize the area where the advertisement is displayed even if the user moves the window to a desired location. Therefore, the advertisement viewing determination unit 17 can surely determine whether the advertisement is on the visual line of the user.

The advertisement viewing time period of the user is then measured. The advertisement viewing determination unit 17 acquires the time that the location on the screen on the visual line enters into the display area of the advertisement as the viewing start time and acquires the time that the location on the screen on the visual line exits from the display area of the advertisement as the viewing end time. The data acquired by the advertisement viewing determination unit 17 is outputted to the advertisement viewing information management unit 20. The advertisement viewing information management unit 20 calculates the advertisement viewing time period from the viewing start time and the viewing end time. In this way, the advertisement viewing time period is measured.

The advertisement viewing information management unit 20 stores the advertisement ID, the viewing start time, the viewing end time, and the advertisement viewing time period of the viewed advertisement in the advertisement viewing information table. In this way, the advertisement viewing information table is created (step S4).

The process of step S4 is continuously executed until the control unit 10 terminates the web browser, and the advertisement viewing information table is continuously updated.

When the control unit 10 terminates the web browser, the update of the advertisement viewing information table is terminated, and the content of the advertisement viewing information table is transmitted to the advertiser (step S5). This allows the advertiser to recognize at what period of time the advertisement is viewed and the viewing time period of the advertisement. Since the measured advertisement viewing time period is accurate, the measured advertisement viewing time period is effective in the measurement of advertising effectiveness, marketing, and recommendation of advertising.

According to the present embodiment, the advertisement viewing information, such as whether the advertisement displayed on an arbitrary location on the monitor is viewed and the viewing time period, can be accurately recognized even if the display area of advertisement changes as the user moves the window on the monitor.

In the present embodiment, the data (advertisement viewing start time, advertisement viewing end time, and advertisement viewing time period) of the advertisement viewing information table is transmitted to the advertiser. However, only the advertisement viewing start time and the advertisement viewing end time may be transmitted as long as the period of viewing the advertisement is transmitted to the advertiser, or only the advertisement viewing time period may be transmitted.

Although the advertisement viewing information table is created for all advertisements in the present embodiment, the table may be created only for the advertisements to be measured. The control unit 10 can analyze the Html data and refers to the tags described in the metadata to determine whether the advertisements are the advertisements to be measured.

In the present embodiment, dedicated software is used to display the window and acquire the viewing information of the advertisement. However, a universal browser may be used to display the window, and dedicated software may be used to acquire the viewing information of the advertisement.

Although the advertisement included in an active window is measured in the present embodiment, the user may be able to view part of an inactive window if the window is not displayed over the entire screen. Therefore, the display area of the advertisement included in the inactive window is calculated, and if the display area is not overlapped the display area of the active window, the advertisement, in addition to the advertisement in the active window, is measured to attain more effective measurement.

In the description of the present embodiment, the advertisement is displayed in the web page displayed in the window. However, not only an application of displaying the advertisement in the same window as the window of the web page, but also an application of displaying the advertisement in a window different from the window displaying the web page is possible. In this case, the location, the size, etc., of the different window displaying the advertisement can be acquired to check, for example, whether the advertisement is viewed.

The web advertising effectiveness measuring apparatus 1 may further include an image analyzing unit for analyzing the images of the face of the user obtained by the imaging unit 15 to detect gender of the user and age of the user, and the gender of the user and the age of the user may be stored in the advertisement viewing information table together with the advertisement viewing start time and the advertisement viewing end time. This enables more detailed analysis and marketing. Various known techniques can be used as a method for analyzing the gender and age from the images of the face.

### Second Embodiment

In the first embodiment, whether the advertisement is on the visual line of the user is determined, and the viewing start time and the viewing end time are acquired based on the result of the determination. However, not only whether the advertisement is viewed, but more detailed information can be acquired.

In a second embodiment of the present invention, whether a text is read is checked when the advertisement is a text. A web advertising effectiveness measuring apparatus 2 of the second embodiment will now be described. The same parts as in the first embodiment are designated with the same reference numerals, and the description will not be repeated.

The eye direction detection unit 16 detects the eye direction of the user from the images of the face of the user taken by the imaging unit 15 and detects a temporal change on the visual line, such as whether the visual line is stopped and in which direction the visual line is moving.

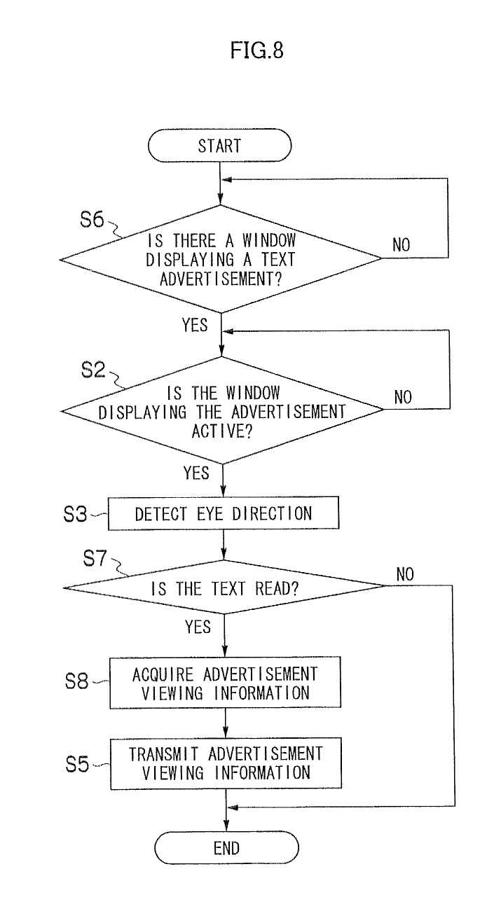

An operation of the web advertising effectiveness measuring apparatus 2 configured this way will be described. The creation and update of the window information table and the advertising site information table are the same as in the first embodiment and will not be described, and a creation process of the advertisement viewing information table will be described. FIG. 8 is a flow chart of a flow of a process for creating the advertisement viewing information table of the second embodiment.

The control unit 10 acquires the window information table and the advertising site information table and determines whether a window of a web page including a text advertisement is displayed on the monitor 11 (step S6). The advertising site information table can be referenced to determine whether the content of the advertisement includes a text.

If the window of the web page including the text advertisement is not displayed on the monitor 11 (NO in step S6), step S6 is executed again.

If the window of the web page including the text advertisement is displayed on the monitor 11 (YES in step S6), the control unit 10 issues an instruction to the active window determination unit 13. The active window determination unit 13 determines whether the window determined to include the text advertisement in step S6 is an active window (step S2). The result of the determination is inputted to the control unit 10.

If the window determined to include the text advertisement in step S6 is not an active window (NO in step S2), step S2 is executed again.

If the window determined to include the text advertisement in step S6 is an active window (YES in step S2), the control unit 10 issues an instruction to the imaging unit 15. The imaging unit 15 continuously takes images of the face of the user in front of the monitor 11, and the eye direction detection unit 16 detects the eye direction of the user from the images of the face of the user taken by the imaging unit 15 (step S3). The detected eye direction of the user is inputted to the advertisement viewing determination unit 17.

The advertisement viewing determination unit 17 measures the location on the screen on the visual line of the user based on the eye direction detected by the eye direction detection unit 16 in step S3. The advertisement viewing determination unit 17 acquires the window information table and the advertising site information table, and based on the data stored in the tables, acquires the display area of the advertisement displayed on the active window. Based on the above mentioned information, the advertisement viewing determination unit 17 determines whether the location on the screen on the visual line is in the display area of the advertisement.

The advertisement viewing determination unit 17 acquires the latest tables every time the window information table or the advertising site information table is updated. As a result, the area where the advertisement is displayed can be recognized even if the user moves the window to a desired location. Therefore, the advertisement viewing determination unit 17 can surely determine whether the advertisement is on the visual line of the user.

The advertisement viewing determination unit 17 further issues an instruction to the eye direction detection unit 16, and the eye direction detection unit 16 detects in which direction the detected visual line of the user is moving. The detected moving direction of the visual line of the user is inputted to the advertisement viewing determination unit 17.

If the moving direction of the visual line of the user inputted from the eye direction detection unit 16 is horizontal, the advertisement viewing determination unit 17 determines that the text of the advertisement is read. The advertisement viewing determination unit 17 acquires the time, when the text of the advertisement is determined to be read, as the viewing start time. The advertisement viewing determination unit 17 acquires the time, when the moving direction of the visual line of the user inputted from the eye direction detection unit 16 is determined not to be horizontal any more, or when the visual line of the user is determined not to be in the display area of the advertisement any more, as the viewing end time.

The data acquired by the advertisement viewing determination unit 17 is outputted to the advertisement viewing information management unit 20. The advertisement viewing information management unit 20 calculates the advertisement viewing time period from the viewing start time and the viewing end time. In this way, the viewing time period of the text of the advertisement is measured.

The advertisement viewing information management unit 20 stores the advertisement ID, viewing start time, viewing end time, and advertisement viewing time period of the viewed advertisement in the advertisement viewing information table. In this way, the advertisement viewing information table is created (step S8).

The process of step S8 is continuously executed until the control unit 10 terminates the web browser, and the advertisement viewing information table is continuously updated.

When the control unit 10 terminates the web browser, the update of the advertisement viewing information table is terminated, and the content of the advertisement viewing information table is transmitted to the advertiser by using contact information of the advertiser acquired by the advertisement information acquisition device (step S5). The contact information includes IP address of a terminal of the advertiser or a electronic mail address of the advertiser.

According to the present embodiment, not only whether the advertisement displayed on an arbitrary location on the monitor is viewed, but also detailed information, such as whether the text of the advertisement is read, can be recognized.

The present invention can be applied not only to an apparatus such as a shared PC (a personal computer) arranged in a cafe, but also to a portable device such as a cell phone with camera. The present invention can be provided not only as an apparatus, but also as a computer program product applied to an apparatus such as a PC.

What is claimed is:

1. A web advertising effectiveness measuring apparatus for measuring a viewing time period of an advertisement on a web page displayed on a display device of a user terminal, the web advertising effectiveness measuring apparatus comprising:
a window information acquisition device for acquiring window information including a location of a window in which the web page is displayed in a screen of the display device and a size of the window;
an advertisement information acquisition device for acquiring advertisement information including a location of the advertisement in the web page and a size of the advertisement;
a display area acquisition device for acquiring a display area of the advertisement on the display device based on the acquired window information and the acquired advertisement information;
an imaging device for taking images of a user, the imaging device being arranged on a predetermined location on the display device;
an eye direction detection device for detecting an eye direction of the user based on the images taken by the imaging device;
a determination device for making a determination whether the advertisement is on a visual line of the user based on the eye direction of the user detected by the eye direction detection device and the display area of the advertisement on the display device acquired by the display area acquisition device;
a viewing time period measuring device for measuring the viewing time period based on a result of the determination by the determination device, the viewing time period being a time period during which the advertisement is determined to be on the visual line of the user; and
a viewing information storage device for linking the viewing time period measured by the viewing time period measuring device and the advertisement information, and storing the viewing time period and the advertisement information.

2. The web advertising effectiveness measuring apparatus according to claim 1, wherein
the window information acquisition device acquires the window information including a location of a scroll bar of the window.

3. The web advertising effectiveness measuring apparatus according to claim 1, further comprising
a device for determining whether the advertisement is viewable by the user when a plurality of windows including the window in which the web page is displayed are overlapped on the display device, wherein
the viewing time period measuring device measures the viewing time period only when the device determines that the advertisement is viewable by the user.

4. The web advertising effectiveness measuring apparatus according to claim 1, wherein
the advertisement information acquisition device acquires information indicating whether the advertisement includes a text,
the eye direction detection device detects a moving direction of the eye direction of the user,
the web advertising effectiveness measuring apparatus further comprising
a device for determining that the user is reading the text if the advertisement information acquisition device acquires the information indicating the advertisement includes the text, the eye direction detection device detects that the eye direction of the user moves horizontally, and the determination device determines that the advertisement is on the visual line of the user.

5. The web advertising effectiveness measuring apparatus according to claim 1, further comprising
a device for revising information including at least one of the location of the window displayed on the display device and the size of the window, wherein
the display area acquisition device acquires the display area of the advertisement on the display device according to the updated information.

6. The web advertising effectiveness measuring apparatus according to claim 1, wherein
the advertisement information acquisition device acquires a contact information of an advertiser of the advertisement,
the web advertising effectiveness measuring apparatus further comprising
a device for transmitting the viewing time period of the advertisement of the advertiser measured by the viewing time period measuring device to the advertiser by using the contact information of the advertiser acquired by the advertisement information acquisition device.

7. A web advertising effectiveness measuring method for measuring a viewing time period of an advertisement on a web page displayed on a display device of a user terminal, the web advertising effectiveness measuring method comprising:
a step of acquiring window information including a location of a window in which the web page is displayed in a screen of the display device and a size of the window;
a step of acquiring advertisement information including a location of the advertisement in the web page and a size of the advertisement;
a step of acquiring a display area of the advertisement on the display device based on the acquired window information and the acquired advertisement information;
a step of acquiring images of a user photographed by an imaging device for taking images of the user, the imaging device being arranged on a predetermined location on the display device;
a step of detecting an eye direction of the user based on the acquired images;
a step of making a determination whether the advertisement is on the visual line of the user based on the detected eye direction of the user and the acquired display area of the advertisement on the display device;
a step of measuring a viewing time period based on a result of the determination in the step of making the determination whether the advertisement is on the visual line of the user, the viewing time period is a time that the advertisement is determined to be on the visual line of the user; and
a step of linking the measured viewing time period and the advertisement information, and storing the measured viewing time period and the advertisement information.

8. A computer program product for measuring a viewing time period of an advertisement on a web page displayed on a display device of a user terminal, the computer program product comprising:
computer-readable program code for causing a computer to acquire window information including a location of a window in which the web page is displayed in a screen of the display device and a size of the window;
computer-readable program code for causing the computer to acquire advertisement information including a location of the advertisement in the web page and a size of the advertisement;
computer-readable program code for causing the computer to acquire a display area of the advertisement on the display device based on the acquired window information and the acquired advertisement information;
computer-readable program code for causing the computer to acquire images of a user photographed by an imaging device for taking images of the user, the imaging device being arranged on a predetermined location on the display device;
computer-readable program code for causing the computer to detect an eye direction of the user based on the acquired images;
computer-readable program code for causing the computer to make a determination whether the advertisement is on the visual line of the user based on the detected eye direction of the user and the acquired display area of the advertisement on the display device;
computer-readable program code for causing the computer to measure a viewing time period based on a result of the determination in the step of determining whether the advertisement is on the visual line of the user, the viewing time period is a time that the advertisement is determined to be on the visual line of the user; and
computer-readable program code for causing the computer to link the measured viewing time period and the advertisement information, and to store the measured viewing time period and the advertisement information.
